(19) United States
(12) Patent Application Publication
(10) Pub. No.: US 2005/0181105 A1
(43) Pub. Date: Aug. 18, 2005

(54) Producing hollow tubular fibers from legume hulls and utilizing such fibers for enhancing flavors and aromas and imparting time-release capabilities for pharmaceuticals and nutraceuticals

(76) Inventors: Dwight G. Triplett, LaVale, MD (US); J.B. Weatherspoon, Glen Ellyn, IL (US); Pie-yi Wang, Wheaton, IL (US)

Correspondence Address: EDELL, SHAPIRO & FINNAN, LLC, 1901 RESEARCH BOULEVARD, SUITE 400, ROCKVILLE, MD, 20850, US

(21) Appl. No.: 10/986,452

(22) Filed: Nov. 12, 2004

Related U.S. Application Data
(60) Provisional application No. 60/518,644, filed on Nov. 12, 2003.

(51) Int. Cl. A23L 1/22

(52) U.S. Cl. 426/534

(57) ABSTRACT

Tubular fibers are produced from legume hulls such as soybean hulls and combined with food products and/or spices to enhance the flavor and aroma of the food products. The tubular fibers further can be combined with pharmaceuticals and neutraceuticals to establish desired time-release profiles for the pharmaceuticals and neutraceuticals when consumed. The fibers are produced utilizing a method and apparatus that increases the fiber yield and minimizes waste material that needs to be processed prior to be disposed.

### CROSS REFERENCE TO RELATED APPLICATIONS

This application claims priority from U.S. Provisional Patent Application Ser. No. 60/518,644, entitled “Method and Product For Enhancing Flavors and Aromas and Imparting Time-Release Capabilites For Pharmaceuticals and Nutraceuticals”, filed Nov. 12, 2003. The disclosure of this provisional patent application is incorporated herein by reference in its entirety.

### BACKGROUND OF THE INVENTION

1. Field of the Invention

The present invention relates to methods and products for enhancing the flavors and aromas of foods and for providing time-release capabilities for pharmaceuticals and neutraceuticals.

2. Description of the Related Art

Dietary fiber has been recognized as an important substance to human health. Insoluble fiber is associated with reducing the risk of digestive disorders, and has been shown to lower the risk of developing certain cancers. According to the National Academy of Science, the recommended dietary fiber intake is 38 grams per day for adult males and 25 grams per day for adult females. In the United States, the median intakes of dietary fiber are 17 and 13 grams per day for men and women, respectively.

The substantial health benefits and the disparity of median intakes have created a strong market demand for dietary fibers and promoted the industry to producing them. U.S. Pat. No. 5,057,334, the disclosure of which is incorporated herein by reference in its entirety, describes a process for the production of fiber cellulose from agricultural by-products such as legume hulls (e.g., soybean hulls). The hulls are comminuted into a particulate feed, which is mixed with water to form slurry. The slurry is then oxidized, hydrolyzed and extracted with a caustic oxidizing agent utilizing an initial pH of about 12 to solubilize non-celllulose material in the feed. The cellulose material is thereafter removed from the slurry by filtration and/or centrifugation. The recovered cellulose solids are mixed with water to form slurry and the slurry pH adjusts to neutral. The hydrogen peroxide is added to the slurry to promote bleaching and further breakdown of the non-cellulose components. The resulting slurry is subjected to a separation operation and residue is recovered and dried to provide the final product.

U.S. Pat. No. 4,307,121, incorporated herein by reference in its entirety, describes a process to produce a cellulose product suitable for human consumption or use in various products. The process employs chlorine gas to solubilize non-cellulose materials present in the feed and then use heat to remove chlorine gas. This process discharge chlorine is environmentally unfriendly and wastewater containing free chlorine inhibits microbial breakdown of the waste materials in the lagoon where the wastewater is stored. Soybean hulls produced utilizing this process typically contain about 43% of crude fiber. This suggests that this method for extracting fiber material from hulls would result in more than 63% of solids being separated with the waste water. Accordingly, a need exists for an improved method and apparatus for producing dietary fibers and reducing waste in disposed water.

In addition, dietary fiber obtained from a variety of plant sources is currently used in the food industry for a number of purposes including, without limitation, fiber fortification, caloric reduction, moisture retention, free water absorption, and as a bulking agent. The fiber fortification is merely designed to increase dietary fiber in foods. The other current uses of fiber in the food industry involve a chemical bond whereby the hydrogen molecule in the water is bonded to the fiber so that the fiber absorbs and retains water. Most fibers are bland in flavor and do not change the flavor profile of foods.

A fiber product that serves to provide the daily dietary requirements and also facilitates an enhancement in flavor and aroma of a food product when combined with the food product is desirable.

### SUMMARY OF THE INVENTION

Therefore, in light of the above, and for other reasons that become apparent when the invention is fully described, an object of the present invention is to provide a method and apparatus for producing dietary fibers and reducing waste in disposed water.

Another object of the present invention is to provide a fiber product that may be combined with a food product (e.g., a liquid, solid and/or granular food product) to enhance the flavor, aroma and overall taste of the food product.

A further object of the present invention is to provide a fiber product that provides time-release capabilities for pharmaceuticals and neutraceuticals.

In accordance with the present invention, a method for enhancing flavor and/or aroma in a food product includes combining hollow tubular fibers formed from legume hulls to the food product. A flavor/aroma enhancer formed in accordance with the present invention includes hollow tubular fibers formed from legume hulls. The fibers can be combined with particulate materials, such as spices or, alternatively, added directly to a food product such as ground meat.

In another embodiment of the present invention, a method for effecting time-release of a pharmaceutical and/or nutraceutical particulate product includes combining the pharmaceutical and/or nutraceutical particulate product with hollow tubular fibers formed from legume hulls such that at least some of the pharmaceutical and/or nutraceutical particulate product is disposed within the hollow tubular fibers. A time-release carrier for pharmaceutical and/or nutraceutical particulate products formed in accordance with the present invention includes hollow tubular fibers formed from legume hulls and including pharmaceutical and/or nutraceutical particulate products disposed within the hollow tubular fibers.

The above and still further objects, features and advantages of the present invention will become apparent upon consideration of the following detailed description of specific embodiments thereof.

### BRIEF DESCRIPTION OF THE DRAWINGS

FIG. 1 is a schematic of an apparatus for producing hollow tubular fibers from legume hulls in accordance with the present invention.

FIGS. 2-5 are microscopic photographs (200× magnification) of tubular fibers produced from soybean hulls in accordance with the present invention and also fiber material produced from hulls of materials other than soybeans and by methods other than those described in accordance with the present invention.

### DESCRIPTION OF THE PREFERRED EMBODIMENTS

The present invention involves the discovery of novel methods and apparatus for forming hollow tubular fibers from various plant cellulose and hemi-cellulose materials, in particular legume hulls, and that such hollow tubular fibers have the capability to receive, surround, encapsulate and slowly release flavors, aromas, and various nutraceutical and pharmaceutical products. This discovery represents an entirely new application for dietary fibers.

The hollow tubular structure of the fiber formed from legume hulls is believed to be dependent upon the plant source of the cellulose and hemi-cellulose and/or the method by which the fiber is extracted. The present invention is a new application of dietary fiber as a (i) a flavor enhancer, (ii) a potential substitute for monosodium glutamate or MSG, (iii) an aroma enhancer, and (iv) a time release agent for flavor, aroma, nutraceutical products and pharmaceutical products. Potential fiber sources include, without limitation, legume hulls such as (i) soybean, (ii) oat, (iii) wheat, (iv) bran, (v) corn, (vi) pea, (vii) citrus, (viii) beet, (ix) wood (alpha cellulose), and (x) cotton. Preferably, soybean hulls are utilized as the raw material for forming the fibers of the present invention.

According to one aspect of the invention, dietary fiber is extracted from legume hulls, such as soybean hulls, using a process such as is described below. Initially, it is noted that the dietary fiber can be formed utilizing the process described in U.S. Pat. No. 5,057,334 (Vail), the entire disclosure of which is incorporated herein by reference. In particular, the process disclosed in the Vail patent yields a hydrated fiber. The resulting hydrated fiber is then dried utilizing a flash drying process, which causes the fiber particles to burst during drying so as to form uniformly sized cylindrical or tubular fiber particles of about 30 microns or less in length and about 10 microns or less in transverse cross-sectional dimension (e.g., diameter).

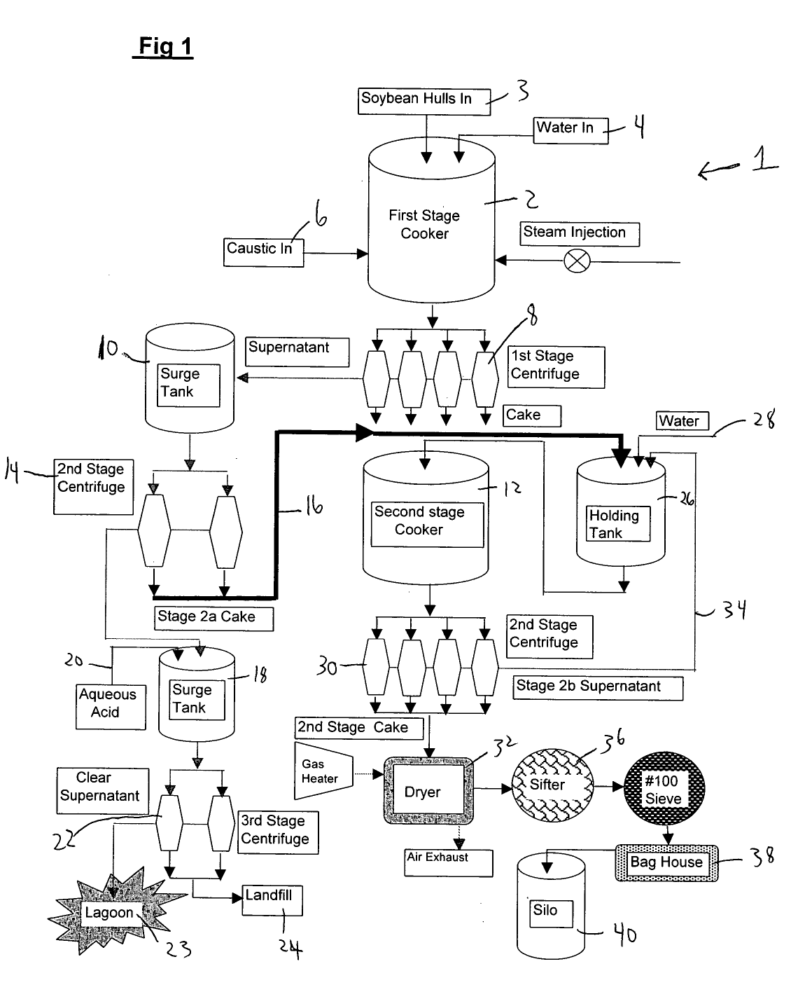

Tubular fibers of similar dimensions can be formed from legume hulls utilizing the process and apparatus as described below and schematically depicted in FIG. 1. Referring to the apparatus 1 of FIG. 1, soybean hulls are weighed and pneumatically transported to a first stage cooker 2. The capacity of the cooker 2 is preferably about 15,000 to 25,000 gallons. Soybean hulls and water are introduced in streams 3 and 4 into cooker 2 at a top opening. The mixing ratio in cooker 2 is one part of soybean hulls with about 10 parts of water. At about the same time, a caustic stream 6 (e.g., sodium or potassium hydroxide, sodium carbonate, or any other suitable caustic agent) is injected at a bottom location into cooker 2. The caustic stream is provided to adjust the pH of the mixture within cooker 2 to a suitable level. In order to improve the uniformity of mixing and cooking, cooker 2 has a shaft with three mixing blades and a circulating pump to mix and to agitate the mixture during cooking continuously.

Upon filling cooker 2 with the hulls, water and the caustic solution, the mixture pH is monitored and preferably maintained between about 10 to 12. The cooker is heated to a temperature of about 200° F. (e.g., via steam). When the cooker 2 reaches the set temperature, the mixture cooks at this temperature for about three hours. The caustic is periodically added to maintain the pH within the preferred range. At the end of cooking, the mixture is pumped to a set of first stage centrifuge system 8 including a plurality of centrifuges arranged in parallel (e.g., four centrifuges). Suitable centrifuges for use in connection with the present invention are Sharple centrifuges, which are commercially available from Alpha Lava Company. The centrifuges separate the mixture into a supernatant that exits to a surge tank 10 for waste water treatment, while the separated cake is delivered for further processing in a second stage cooker 12.

After being cooked at high temperature and with a high caustic solution in the first stage cooker 2, the soybean hulls have decomposed to many soluble and insoluble compounds. In order to obtain a high quality of dietary fiber in the final product, the first stage centrifuge system 8 is preferably run at a flow rate of about 40 gallons per minute and 4000 rpm bowl speed with a differential speed between bowl and augur of about 14 rpm. Under these operating conditions, a substantial amount of fiber can still be discharged with supernatant. Thus, to improve yield, a second stage centrifuge system 14 including multiple centrifuges in parallel (e.g., two or more) is provided downstream from surge tank 10 and configured to operate at different conditions to recover more fibers from the first stage discharged slurry that exits the surge tank. The second stage centrifuge system 14 is operated at a flow rate of about 75 gallons per minute and 3000 rpm bowl speed with a differential speed between bowl and augur of 6 rpm. Exemplary centrifuges that are suitable for use in the second stage centrifuge system 14 are Centrisys Models, which are commercially available from Centrisys Company (Lodi, Wis.). The fiber cake recovered from the second stage centrifuge system 14 are delivered in a stream 16 then blended with the fiber cake recovered from the first stage centrifuge system 8 for further processing. The supernatant from the second stage centrifuge system 14 is pumped to a second surge tank 18.

After two stages of centrifuge separation have occurred, most insoluble fibers have been removed from the supernatant. The supernatant in the second surge tank 18 contains mostly soluble compounds that are about 5% of the supernatant concentration. The supernatant in surge tank 18 is then adjusted to a pH of about 4 with a suitable aqueous acid provided by stream 20, preferably phosphoric acid, to precipitate the soluble compounds.

After the precipitation process, the resultant slurry is pumped to a third stage centrifugation system 22 including a plurality of centrifuges in parallel (e.g., two or more) to remove the precipitated materials. The supernatant after the third stage centrifuge is clear and is discharged for wastewater treatment (e.g., in a lagoon 23 as generally designated in FIG. 1). The removed solids from third stage centrifuge system 22 are disposed to a suitable land fill (designated as number 24 in FIG. 1).

The cake from first stage centrifuge system 8 is conveyed to a holding tank 26, where it is combined with the cake removed from the second stage centrifuge system 14. In the holding tank 26, one pound of cake is mixed with 0.5 gallons of water (input via stream 28) and the mixture is then pumped to the second stage cooker 12. The second stage cooker 12 is similar in configuration as the first stage cooker 2 and includes mixing blades and a circulation pump. The mixture pH in cooker 12 is adjusted to 6.5 to 7.5 with aqueous acids, preferably phosphoric acid. The neutralized mixture is agitated and bleached with aqueous hydrogen peroxide. The usage of hydrogen peroxide is about 0.02 parts to one part of mixture by weight. The mixture is then heated to about 200° F. and held at this temperature for about 3 hours to further breakdown of non-cellulose materials and bleaching of product. The bleached mixture is then pumped to a second stage centrifuge system 30 to harvest the dietary fiber. Multiple centrifuges are arranged in parallel (e.g., four centrifuges) for the system 30. The cake discharged from centrifuge system 30 is conveyed to a dryer as described below. The supernatant from system 30 is pumped in a stream 34 to holding tank 26.

The cake from centrifuge system 30 contains about 30% solids and about 70% moisture. The wet cake is conveyed into a thermal jet dryer 32 that is commercially available from Fluid Energy Aljet (Telford, Pa.). A hot gas is deliverd from a gas heater 34 into dryer 32 through nozzles to create a high velocity and rotate gas and wet cake stream. The gas steam rapidly sweeps the incoming wet cake into the drying chamber where the turbulent hot air quickly deagglomerates the wet cake by creating particle to particle collisions. These collisions decrease the particle size, increase particle surface area and promote rapid drying.

After drying, particles have a substantial variation in size and also include insoluble non-cellulose materials that can cause a gritty taste or feel in the mouth. Therefore, the product out of thermal jet dryer 32 is introduced into a sifter 36, such as a Sweco In-line Sifter that is commercially available from Sweco (Florence, Ky.). In the sifter 36, the product is further deagglomerated with strongly vibrating plastic balls and filtered with a screen that has openings in the size range of about 70 to 120 mesh, preferably 100 mesh. The particles and foreign materials larger than the mesh size are filtered from the smaller particulate fiber material, and the smaller fiber material passing through the screen are pneumatically transported to the final collector 38. The final collector 38 consists of several Mac bags, which are arranged in parallel or conventionally referred to as a bag-house. The collected fibers in the bag are periodically vibrated to drop to a storage silo 40. From silo 40, products are delivered for packaging. The combination of the thermal jet dryer and sifter yields a fiber product that breaks down agglomerated fibers and has a uniform and desirable particle size that is suitable for use in applications such as aroma and flavor enhancing products and pharmaceutical/neutraceutical time-release products.

The tubular fibers formed from any of the previously described processes and apparatus include open ends and a hollow channel or bore along the entire length of the fibers formed. Tubular fibers formed in this manner are suitable for enhancing flavors and aromas in foods and for serving as time-release agents for pharmaceuticals and neutraceuticals and further have generally uniform dimensions. In particular, fibers have been formed utilizing the processes described above with dimensions averaging in the range of about 16 to about 24 microns in length and about 4 microns in diameter.

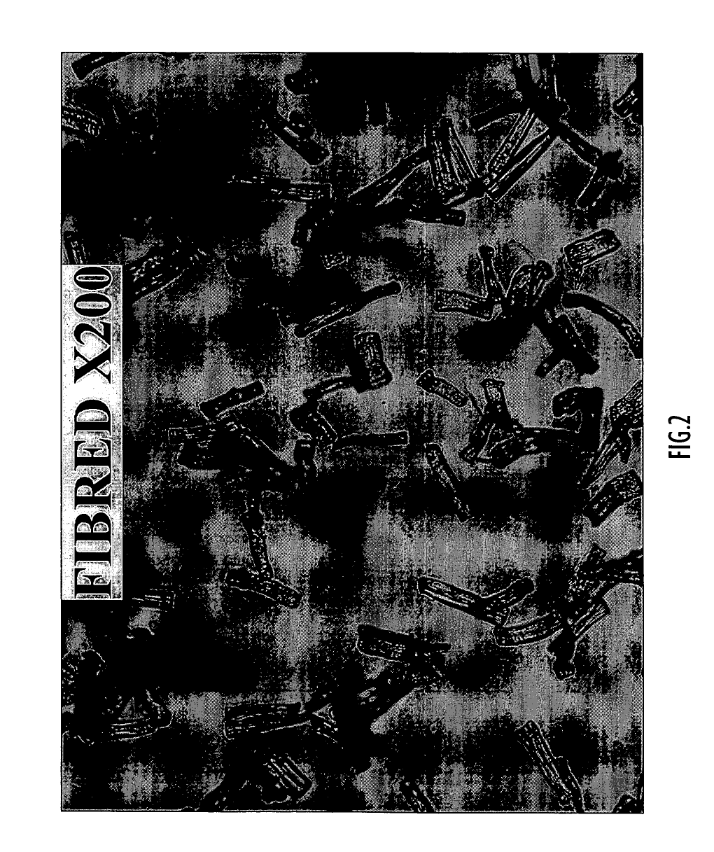

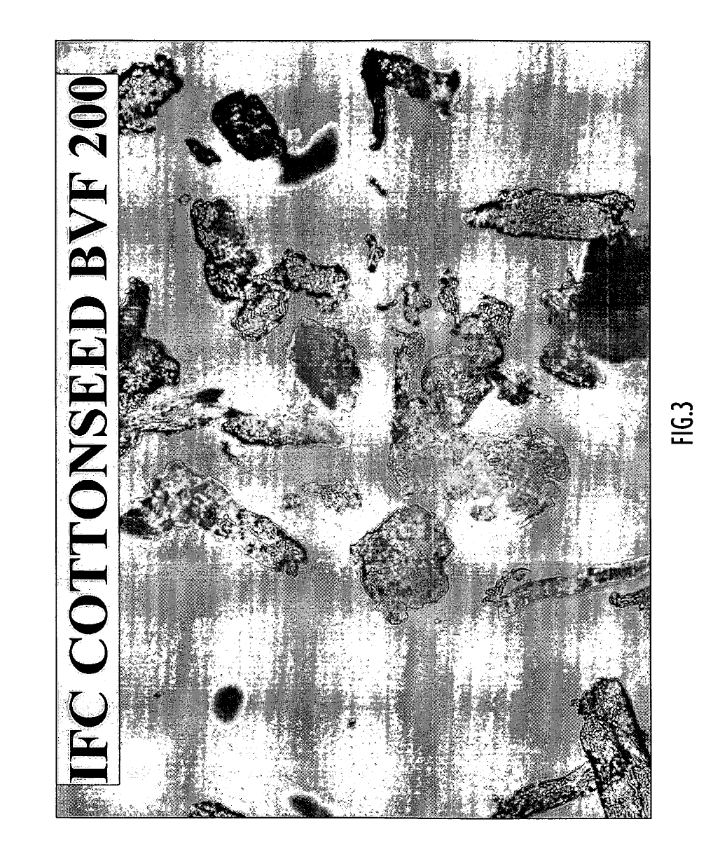

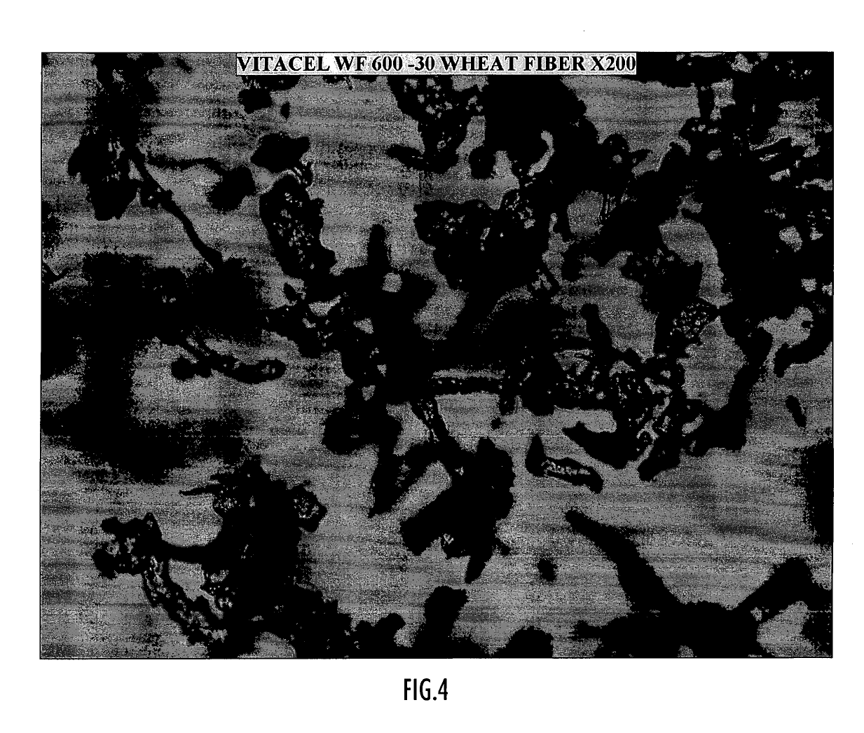

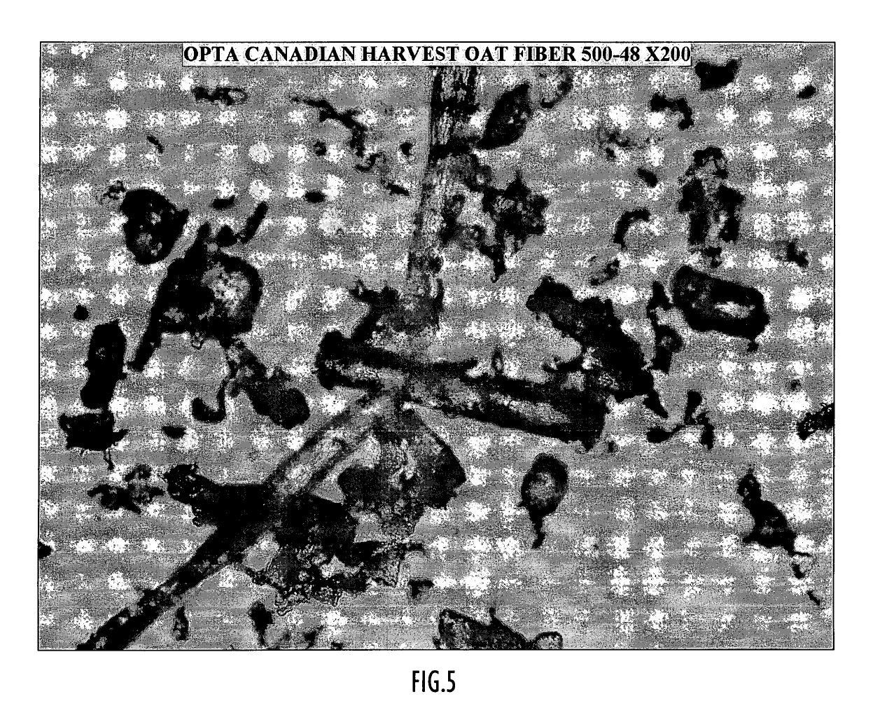

A microscopic photograph (at 200× magnification) of fibers formed utilizing any of the processes described above is depicted in FIG. 2. It can be seen from the photograph that the tubular fibers are generally uniform in size and shape, are very clean and are substantially free from other extraneous material. FIGS. 3-5 depict microscopic photographs (at 200× magnification) of fibers produced from other materials and by different processes. In particular, FIG. 3 depicts fibers formed from cottonseed and commercially available from International Fiber Corporation (North Tonawanda, N.Y.) under the trademark JUST FIBER®; FIG. 4 depicts wheat fibers that are commercially available from J. Rettenmaier USA (Schoolcraft, Mich.) under the trademark VITACEL®; and FIG. 5 depicts oat fibers that are commercially available from Opta Food Ingredients, Inc. (Bedford, Mass.) under the trademark CANADIAN HARVEST®. The fibers of FIGS. 3-5 are not as uniform in shape and size and further contain more extraneous material and are not as clean as the fibers produced in accordance with the present invention and depicted in FIG. 2.

The generally uniform tubular fibers formed according to the present invention above can be combined with a variety of solid, semi-solid, liquid, gelatinous and/or granular, powdered or particulate food products to enhance the overall flavor and aroma of the food products. For example, the fibers can be mixed with meat products (e.g., ground beef, pork, turkey, chicken, etc.) to enhance the flavor of the meat during consumption. Alternatively, the fibers can be combined with liquid food products (e.g., soups, coffee, tea, etc.) to enhance the aroma and flavor of these products.

The fibers can also be mixed with granular, particulate or powdered materials such as spices. The fibers can be mixed with any conventional or unconventional spices including, without limitation, herbs, salt (i.e., sodium chloride), ground pepper, dried and ground or powdered fruits and vegetables (e.g., onion powder, garlic powder, cinnamon powder, ground sage, ground cumin, ground oregano, etc.). Optionally, the fibers are combined with one or more spices and further pulverized to form a fine and uniform powder. The powder including the mixture of one or more spices can then be added to other food products to enhance the aroma and flavors of the food products.

The fibers can be mixed with one or more spices at any suitable ratio depending upon a particular application. For example, a spice product including a weight percentage ratio of fibers to spice (e.g., salt) can be, for example, 10:90, 20:80, 30:70, 40:60, and even 50:50 or higher depending upon a particular application while maintaining or even intensifying the aroma and flavor enhancing effect of the particular spice upon a particular food product to which the spice is added in comparison to utilizing the particular spice by itself (i.e., at a ratio of 0:100 fibers to spice) and in the same concentration with the food product. The addition of the fibers to spices intensifies the flavor and aroma enhancing effect of the spices themselves, reduces the amount of spices that need to be added to a food product to retain a desired flavor profile, and results in a slow release of the flavor and aroma of the spices over time while minimizing the loss of flavor and aroma during the cooking process.

It is believed that the tubular configuration and small size (i.e., on the micron level) of the fibers plays an important role in enhancing aroma and flavor of the food product to which the fibers are added. In addition, it has been determined that the addition of the fibers to meat products such as ground beef will result in a higher level of fat retention in the meat product after cooking in comparison to meat products that do not include the fibers. The higher fat retention in meat products is believed to be at least one factor in enhancing the flavor and aroma of the meat product during consumption. Further, it is believed that the structure of the fibers can be used to encapsulate and slowly release other agents besides flavors and aromas. Specifically, it is believed that pharmaceutical products and nutraceutical products can be encapsulated with the fiber and released in a desired time-release profile when consumed by an individual.

The following are processing examples utilizing the apparatus as described above and illustrated in FIG. 1.

### EXAMPLE 1

Starting materials were provided to the first stage cooker as follows: 15,000 pounds of soybean hulls and 14,500 gallons of water are mixed in the first stage cooker 2. The pH of soybean hulls and water mixture is adjusted to 12 with sodium hydroxide. The mixture was then heated up to 200° F. and cooked at this temperature for 3 hours. The resulting slurry was centrifuged in the first stage centrifuge system 8. The cake was transferred to the holding tank 26 and the supernatant was discarded to waste water treatment. Then the cake was mixed with water in the holding tank 26. The mixing ratio was one part of wet cake with 0.5 gallon of water. The slurry was then transferred to the second stage cooker 12, and phosphoric acid was added to the second stage cooker 12 to adjust the pH of the slurry to 7. At the same time, hydrogen peroxide was added to bleach the slurry. The slurry was heated up to 200° F. and cooked at this temperature for 3 hours. After cooking, the slurry was centrifuged and transferred to the thermal jet dryer 32. The dried products were conveyed to the bag-house 38 and packaged. The finish weight was 5650 pounds or the yield of 36.67%. The finished product includes hollow tubular fibers with particle sizes ranging from 5 to 600 microns.

### EXAMPLE 2

This example was carried out in the same manner as Example 1, with the exception that products from the thermal jet dryer 32 were conveyed to a Sweco sifter 36 where the products were ground with vibrating plastic balls and filtered with 100 mesh screen. The products after segregation and filtering were transferred pneumatically to the bag-house 38 and packaged. The finish weigh was 5400 pounds or 36% of yield. The sifter removed 250 pounds of large non-cellulose particles or a loss of 1.67% of yield. The hollow tubular particles in the final product had sizes ranging from 5 to 80 microns with a median value of 28.84 microns.

### EXAMPLE 3

This example was carried out in the same manner as Example 1, with the further feature of 3000 pounds of wet cake being recovered by the second stage centrifuge system 14 from the supernatant exiting the first stage centrifuge system 8. The supernatant from the second stage centrifuge system 14 was discharged to the waste water treatment. The wet cake from second stage centrifuge system 14 was conveyed to the holding tank 26 and blended with the cake delivered from the first stage centrifuge system 8. Thereafter, the process follows the same steps as Example 2. The finished products weight 6150 pounds for a yield of 41% and had a particle size the same as for Example 2.

The above examples indicate that the process and apparatus as described above and depicted in FIG. 1 provide an effective yield of tubular fibers having desired dimensions while effectively minimizing waste material that requires further processing prior to being sent to a landfill site.

The following are examples showing the flavor and aroma enhancing effect of fibers formed in accordance with the present invention which are combined with food products.

### EXAMPLE 4

A commercially available sausage product was prepared with both tubular soy fibers produced according to the invention and also cotton fibers commercially available from International Fiber Corporation for comparison purposed against a control (i.e., no addition of soy or cotton fibers to the sausage product). In particular, a chub sausage product commercially available under the tradename Giant Eagle Private Label was provided in patties as the raw food material. The sausage product was formed into 2-ounce patties into the following three test or sample groups: 1. control group (no soy or cotton fiber additives); 2. a soy fiber group (including soy fibers of the present invention); and 3. a cotton fiber group (including cotton fibers). The soy fiber patties and cotton fiber patties needed for the taste tests were produced in batches by blending 16 ounces of the sausage product with 0.480 ounces of the soy or cotton fiber and 1.92 ounces of water, and then forming 2-ounce patties for each of the soy fiber and cotton fiber groups.

The patties of each of the control, soy fiber and cotton fiber groups were cooked to an internal temperature of about 71° C. (165° F.). A panel of eight randomly selected individuals was assembled to conduct a blind taste test with the three groups of cooked patties. The same blind taste test was then conducted a second time with another panel of eight different and randomly selected individuals. The individuals in each panel test consumed at least part of a sausage from each of the control, soy fiber and cotton fiber groups, and provided their opinions as to which sausage had the best flavor and taste. The results of the taste test are provided in Table 1 below:

TABLE 1
Results of Taste Test for Chub Sausage

| | Control Group | Soy Fiber Group | Cotton Fiber Group |
|---|---|---|---|
| Preference for | 1 | 6 | 1 |
| First Panel | | | |
| Taste Test | | | |
| Preference for | 2 | 6 | 0 |
| Second Panel | | | |
| Taste Test | | | |
| Total | 3 | 12 | 1 |
| Percentage | 18.75% | 75% | 6.25% |

As can be seen from the blind taste test, the chub sausage patties that included the soy fiber of the present invention blended with the sausage meat was the most preferred in comparison to the control group and the cotton fiber group. In addition, the panelists indicated that the patties of the cotton fiber group were not as moist (i.e., more dry) in taste in comparison to the patties of the soy fiber group, indicating that the patties of the soy fiber group retained more moisture after cooking than the other two groups.

### EXAMPLE 5

Soy fiber produced in accordance with the present invention was added to ground beef along with water in various concentrations, where the starting fat or lipid concentration in the ground beef varied between 20% fat and 30% fat. The soy fiber, water and ground beef were uniformly mixed together for the various test samples utilizing a LeLand Meat Mixer, with the following samples being formed as set forth in Table 2 below:

TABLE 2
Concentrations (w/w) of Fibers and Water in Ground Beef Samples

| Formulation | Ground beef | Fiber | Water | Total |
|---|---|---|---|---|
| Control | 100% | 0% | 0% | 100% |
| Sample 1 | 85% | 5% | 10% | 100% |
| Sample 2 | 80% | 5% | 15% | 100% |
| Sample 3 | 75% | 5% | 20% | 100% |
| Sample 4 | 80% | 10% | 10% | 100% |
| Sample 5 | 70% | 10% | 20% | 100% |

Quarter pound patties were prepared from the samples and frozen in a blast freezer (−37° C.; −20° F.), weighed, vacuum-packaged, and stored in a research freezer at −20° C. (0° F.). Prior to freezing, five random patties from each group were pooled for chemical analysis. Patties were then thawed in vacuum bags, and any liquid was drained from the bags and the patties were reweighed to determine the amount of water and mass lost from the thawing process. As can be seen from the data obtained from the draining process and provided in Table 3 below, the addition of fiber to both the beef patty samples containing 20% and 30% fat content reduced the drainage of water and other materials from the patties during thawing:

TABLE 3
Drainage from raw ground beef patties upon thawing

| | | | 30% Fat | |
|---|---|---|---|---|
| | 20% Fat | | Mass loss | |
| Sample | Mass loss (%) | H₂O lost (%)¹ | (%) | H₂O lost (%)¹ |
| Control | 2.70 | 4.11 | 1.08 | 2.00 |
| Sample 1 | 2.00 | 2.99 | 1.38 | 2.29 |
| Sample 2 | 2.14 | 3.23 | 1.78 | 2.88 |
| Sample 3 | 4.93 | 7.57 | —² | —² |
| Sample 4 | 1.86 | 2.85 | 0.30 | 0.49 |
| Sample 5 | 3.99 | 6.02 | 0.23 | 0.40 |

¹When calculating percent water lost it is assumed that the mass lost upon thawing is entirely water; some proteins + salts are also lost, but assumed negligible.
²Data not available.

The thawed patties were then cooked at 185° C. (365° F.) for approximately 6 min in an impingement oven to an internal temperature of >71° C. (>165° F.) as measured by a thermocouple placed in the core of each patty. After cooking, patties were cooled on a screen for 5 minutes at room temperature, and then re-weighed/measured to determine cook-loss and shrink. Five random cooked patties from each group were pooled for chemical analysis to determine moisture and fat retention. The shrinkage (i.e., percent decrease in patty size) and yield (i.e., percentage of cooked patty mass to raw patty mass) was measured for each of the cooked patties, as well as the moisture and fat or lipid concentration (w/w) for both the raw and cooked patties. The data for each of these measurements is provided in Tables 4-6 set forth below:

TABLE 4
Yields and shrinkage of ground beef patties upon cooking

| | 20% Fat | | 30% Fat | |
|---|---|---|---|---|
| | Cook | Cook | Cook | Cook |
| Sample | Yield (%) | Shrink (%) | Yield (%) | Shrink (%) |
| Control | 71.5 ± 1.3 | 18.6 ± 6.2 | 61.3 ± 1.5 | 25.0 ± 3.4 |
| Sample 1 | 74.4 ± 0.7 | 16.8 ± 4.2 | 68.3 ± 1.4 | 17.2 ± 3.0 |
| Sample 2 | 73.7 ± 0.6 | 15.5 ± 2.7 | 67.8 ± 0.8 | 16.4 ± 2.5 |
| Sample 3 | 73.6 ± 0.8 | 13.5 ± 6.3 | 67.3 ± 1.0 | 16.0 ± 3.5 |
| Sample 4 | 75.6 ± 0.9 | 11.9 ± 2.6 | 72.7 ± 0.9 | 12.6 ± 2.3 |
| Sample 5 | 74.5 ± 0.7 | 13.2 ± 5.5 | 72.0 ± 1.1 | 12.7 ± 2.3 |

TABLE 5
Chemical composition of raw and cooked ground beef patties
(initially approximately 20% total lipids)

| | | | Cooked | |
|---|---|---|---|---|
| | Raw | | | Total |
| Sample | Moisture (%) | Total Lipids (%) | Moisture (%) | Lipids (%) |
| Control | 65.67 ± 0.14 | 15.35 ± 0.30 | 53.96 ± 0.19 | 15.90 ± 0.08 |
| Sample 1 | 66.72 ± 0.21 | 11.84 ± 0.05 | 54.22 ± 0.33 | 16.92 ± 0.23 |
| Sample 2 | 66.41 ± 0.25 | 12.24 ± 0.16 | 53.44 ± 0.50 | 18.67 ± 0.05 |
| Sample 3 | 65.17 ± 1.46 | 11.47 + 0.03 | 56.94 ± 0.20 | 15.69 ± 0.16 |
| Sample 4 | 65.30 ± 0.71 | 10.72 ± 0.17 | 53.01 ± 0.25 | 14.58 ± 0.58 |
| Sample 5 | 66.37 ± 0.44 | 9.06 ± 0.04 | 55.09 ± 0.18 | 14.21 ± 0.10 |

TABLE 6
Chemical composition of raw and cooked ground beef patties
(initially approximately 30% total lipids)

| | | | Cooked | |
|---|---|---|---|---|
| | Raw | | | Total |
| Sample | Moisture (%) | Total Lipids (%) | Moisture (%) | Lipids (%) |
| Control | 54.08 ± 0.89 | 27.32 ± 0.20 | 49.65 ± 0.48 | 25.60 ± 0.37 |
| Sample 1 | 60.51 ± 2.97 | 22.04 ± 0.17 | 48.02 ± 0.08 | 27.15 ± 1.02 |
| Sample 2 | 61.78 ± 0.26 | 23.90 ± 0.89 | 48.26 ± 0.01 | 28.25 ± 0.03 |
| Sample 3 | 60.90 ± 0.08 | 21.98 ± 0.14 | 49.08 ± 0.35 | 31.27 ± 1.75 |
| Sample 4 | 62.61 ± 0.21 | 17.96 ± 3.31 | 52.02 ± 0.65 | 22.50 ± 0.23 |
| Sample 5 | 58.42 ± 0.41 | 17.96 ± 0.07 | 50.19 ± 0.56 | 25.39 ± 1.20 |

As can be seen from the tabulated data provided above, the addition of soy fiber to the ground beef patties improves moisture retention and significantly increases fat retention in the patties during cooking. The retention of fat is believed to have an important impact on the product flavor.

Thus, it can be seen that the fibers formed according to the present invention are capable of enhancing flavors and aromas of food products when added to the food products. The fibers of the present invention can further be combined with spices to intensify the flavor and aroma enhancing effect of the spices while reducing the concentration of the spices necessary to achieve a desired aroma and flavor for the food product to be consumed.

Having described preferred embodiments of methods and products for enhancing flavors and aromas and imparting time-release capabilites for pharmaceuticals and nutraceuticals, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

1. A method for enhancing flavor and/or aroma in a food product comprising combining hollow tubular fibers formed from legume hulls with the food product.

2. The method of claim 1, wherein the legume hulls comprise soybean hulls.

3. The method of claim 1, wherein the food product comprises a particulate material.

4. The method of claim 2, wherein the food product comprises a spice.

5. The method of claim 4, wherein the legume hulls comprise soybean hulls, and the fibers are combined with the spice at a weight percentage of no greater than about 50% fibers in relation to a combined weight of the fibers and the spice.

6. The method of claim 5,wherein the spice comprises salt.

7. The method of claim 1, wherein the food product comprises ground meat.

8. The method of claim 1, wherein the food product comprises a liquid.

9. A method for effecting time-release of a pharmaceutical and/or nutraceutical particulate product comprising combining the pharmaceutical and/or nutraceutical particulate product with hollow tubular fibers formed from legume hulls such that at least some of the pharmaceutical and/or nutraceutical particulate product is disposed within the hollow tubular fibers.

10. A flavor/aroma enhancer comprising hollow tubular fibers formed from legume hulls.

11. The enhancer of claim 10, further comprising a particulate material combined with the tubular fibers formed from legume hulls.

12. The enhancer of claim 11, wherein the particulate material comprises a spice.

13. The enhancer of claim 12, wherein the legume hulls comprise soybean hulls, and the fibers are combined with the spice at a weight percentage of no greater than about 50% fibers in relation to a combined weight of the fibers and the spice.

14. The enhancer of claim 13, wherein the spice comprises salt.

15. A time-release carrier for pharmaceutical and/or nutraceutical particulate products comprising hollow tubular fibers formed from legume hulls and including pharmaceutical and/or nutraceutical particulate products disposed within the hollow tubular fibers.

16. A method of producing dietary fibers comprising:
forming a mixure of soybean hulls with water and adjusting the pH of the mixture to 12.0;
heating the mixture in a cooker to form a slurry;
delivering the slurry to a first stage centrifuge system to separate insoluble fibers from a first supernatant solution;
delivering the first supernatant solution to a second stage centrifuge system to separate insoluble fibers from a second supernatant solution;
combining the insoluble fiber separated from the first and second supernatant solutions together with water to form a second mixture;
heating the second mixture in a cooker to form a second slurry;
delivering the second slurry to a second stage centrifuge system to separate insoluble fibers from a third supernatant solution;
delivering the insoluble fibers from the second stage centrifuge system to a deagglomeration dryer to remove moisture and reduce particle size of the insoluble fibers; and
grinding and screening the dried insoluble fibers to achieve fibers with selected dimensions.
